(19) United States
(12) Patent Application Publication
(10) Pub. No.: US 2025/0305526 A1
(43) Pub. Date: Oct. 2, 2025

(54) Double Ended Hybrid Stud Fastener Assembly

(71) Applicant: Illinois Tool Works Inc., Glenview, IL (US)

(72) Inventors: Sean Anthony Tomaselli, West Bloomfield, MI (US); Lucas Kroeger, Fenton, MI (US); Scott Liebelt, Chippewa Falls, WI (US); Louis Meli, Sterling Heights, MI (US)

(21) Appl. No.: 19/078,016

(22) Filed: Mar. 12, 2025

Related U.S. Application Data
(60) Provisional application No. 63/573,420, filed on Apr. 2, 2024.
(60) Provisional application No. 63/657,525, filed on Jun. 7, 2024.

(51) Int. Cl. F16B 5/02; F16B 43/00

(52) U.S. Cl. CPC F16B 5/0275; F16B 43/001

(57) ABSTRACT

Disclosed is a fastener assembly to couple a first component to a second component via an opening associated with the first component and a doghouse structure associated with the second component. The fastener assembly includes a double-sided stud, a plastic base component, and a seal. The double-sided stud having a first shank and a second shank. The second shank passes through the opening to secure with a nut; a plastic base component having a first platform spaced apart from a second platform via a stem. The plastic base component defines a passageway configured to receive at least a portion of the first shank. The first platform is configured to secure with the doghouse structure; and a seal coupled to the second platform.

### RELATED APPLICATIONS

The present application claims priority to U.S. Provisional Patent Application Nos. 63/573,420, filed Apr. 2, 2024, and 63/657,525, filed Jun. 7, 2024, each entitled “Double Ended Hybrid Stud Fastener Assembly,” which are hereby incorporated by reference in their entirety.

### BACKGROUND

Automotive components require fastening techniques that are simple to manufacture and assemble. Further, fastening techniques should above all be reliable and efficient. Automobile assemblies, for example, include various panels and structures connected to other panels or structures, or to the automobile frame itself.

A double-ended stud fastener, often simply called a double-ended stud or threaded stud, can be used to secure various components together. The double-ended stud fastener is a type of fastener that has threads on both ends with an unthreaded section in the middle. It is used to join two components together, where one end of the stud is screwed into a tapped hole, and the other end receives a nut or is screwed into another tapped hole. In various applications, fasteners of different sizes, shapes, configurations and/or the like are used to secure components together.

Despite advancements to date, it would be highly desirable to have a fastener system that uses a double-ended stud with a dog house structure.

### SUMMARY

The present disclosure relates generally to a fastener system, substantially as illustrated by and described in connection with at least one of the figures, as set forth more completely in the claims. More specifically, the present disclosure relates generally to a fastener system with a double-ended stud configured to engage a doghouse structure via a sealed, plastic base assembly.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a side elevation assembly view of a fastener system having a stud fastener assembly in accordance with an aspect of this disclosure.

FIG. 1b illustrates a side elevation assembled view of the fastener system in accordance with an aspect of this disclosure.

FIG. 1c illustrates an isometric assembly view of the stud fastener assembly.

FIG. 1d illustrates an isometric assembled view of the stud fastener assembly.

FIG. 1e illustrates a top plan view of the stud fastener assembly.

FIG. 1f illustrates a side elevation view of the stud fastener assembly.

FIG. 1g illustrates a side elevation cross-sectional view of the stud fastener assembly taken along cutline A-A (FIG. 1e).

FIG. 2a illustrates a side elevation view of a base assembly of the stud fastener assembly of FIGS. 1a through 1g in accordance with an aspect of this disclosure.

FIG. 2b illustrates a side elevation view of the base assembly taken along cutline A-A (FIG. 1e).

FIG. 3 illustrates a side elevation view of a double-ended stud of the stud fastener assembly of FIG. 1a through 1g in accordance with an aspect of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“ e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastener system with a double-ended stud configured to engage a doghouse structure via a plastic base assembly having a base component and a seal. The base component may have a shape with a first platform spaced from and connected to a second platform by a stem. The stem has a passageway (e.g., an opening or channel) therethrough for accommodation of the first shank of the double-sided stud, which is threaded into the passageway for retention therein. The seal may be a softer plastic than the base component and may be over molded onto the second, upper platform to attach the seal thereto. Gaps are formed between the first and second platforms around the stem such that the base component can be inserted into a doghouse structure. When assembled, the base component is attached to a doghouse structure, the second shank of the double-ended stud is attached to a component (e.g., a spoiler) via an opening therein and a nut, where the seal forms a watertight barrier with the component.

In one example, a fastener assembly to couple a first component to a second component via an opening associated with the first component and a doghouse structure associated with the second component comprises: a double-sided stud having a first shank and a second shank, wherein the second shank is configured to pass through the opening to secure with a nut; and a base component having a first platform spaced apart from a second platform via a stem, wherein the base component defines a passageway configured to receive at least a portion of the first shank, and wherein the first platform is configured to secure with the doghouse structure.

In another example, a base component to couple a first component to a second component via a double-sided stud having a first shank and a second shank comprises: a first platform; and a second platform spaced apart from the first platform via a stem, wherein the base component defines a passageway configured to receive at least a portion of the first shank, and wherein the first platform is configured to secure with a doghouse structure formed on the second component.

In yet another example, a fastener assembly to couple a first component to a second component via an opening associated with the first component and a doghouse structure associated with the second component comprises: a double-sided stud having a first shank and a second shank, wherein the second shank is configured to pass through the opening to secure with a nut; a plastic base component having a first platform spaced apart from a second platform via a stem, wherein the plastic base component defines a passageway configured to receive at least a portion of the first shank, and wherein the first platform is configured to secure with the doghouse structure; and a seal coupled to the second platform.

In some examples, the fastener assembly further comprised a seal.

In some examples, the seal is coupled to the second platform.

In some examples, the second shank comprises as its distal end a head.

In some examples, the head is configured to define one or more driver shapes.

In some examples, the base component is plastic.

In some examples, the double-sided stud is metal.

In some examples, the seal is a foam material, thermoplastic, or a rubber.

In some examples, the double-sided stud comprises a collar positioned between the first shank and the second shank.

In some examples, the collar is configured to abut the second platform when assembled.

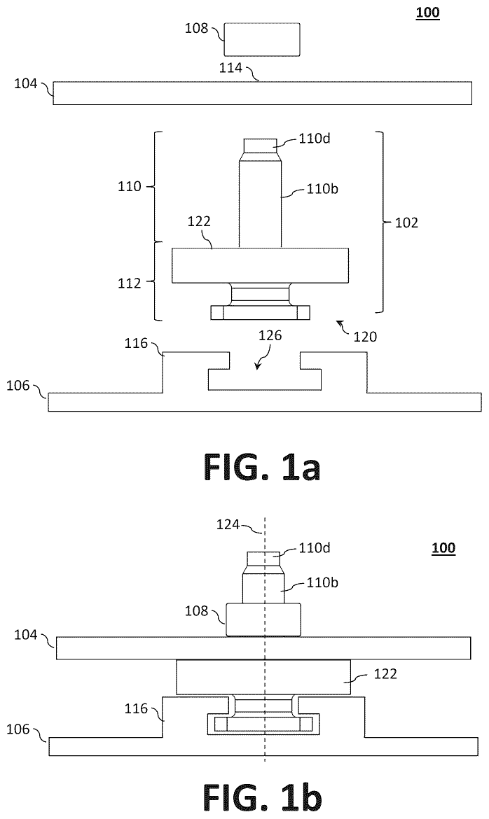

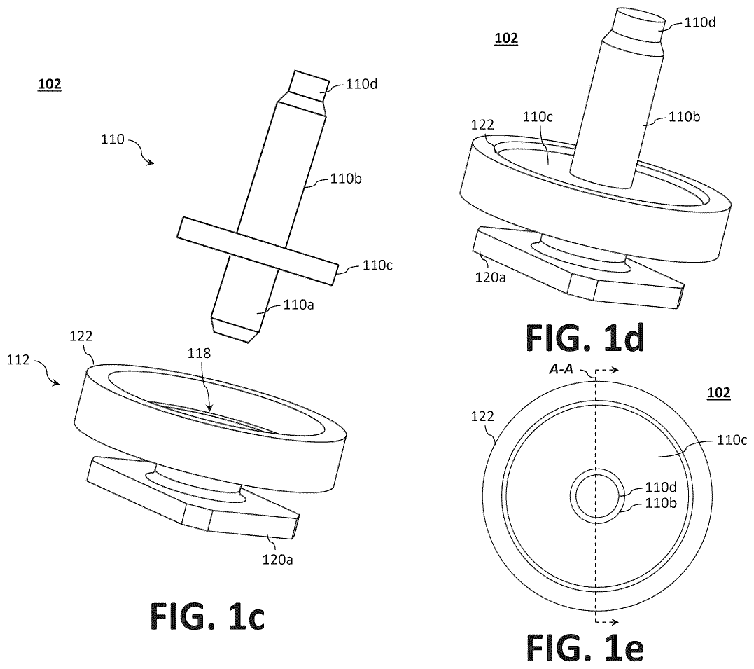

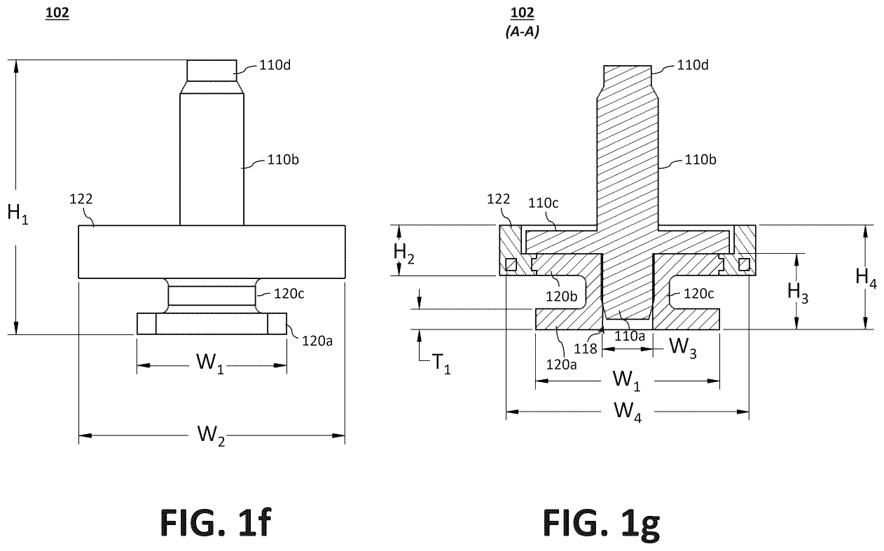

FIG. 1a illustrates a side elevation assembly view of a fastener system 100 having a stud fastener assembly 102 in accordance with an aspect of this disclosure. FIG. 1b illustrates a side elevation assembled view of the fastener system 100 in accordance with an aspect of this disclosure. FIGS. 1c and 1d illustrate, respectively, isometric assembly and assembled views of the stud fastener assembly 102. FIG. 1e illustrates a top plan view of the stud fastener assembly 102, while FIG. 1f illustrates a side elevation view of the stud fastener assembly 102. FIG. 1g illustrates a side elevation cross-sectional view of the stud fastener assembly 102 taken along cutline A-A (FIG. 1e).

The illustrated fastener system 100 includes the stud fastener assembly 102, a first component 104, and a second component 106. The stud fastener assembly 102 is configured to join the first component 104 and the second component 106 via, for example, a nut 108 and/or one or more features formed in or on the first component 104 and the second component 106. In this example, the stud fastener assembly 102 generally comprises a double-ended stud 110 and a base assembly 112.

As illustrated, each of the first component 104 and the second component 106 can include one or more engagement features that facilitate attachment with the stud fastener assembly 102. For example, the first component 104 is illustrated as having an opening 114 formed therein, while the second component 106 is illustrated as having a doghouse structure 116 formed thereon. As illustrated, the doghouse structure 116 defines a slot 126. The opening 114 and/or doghouse structure 116 can be formed in or on the first component 104 and/or the second component 106 during manufacturing thereof or added post-manufacture through a mechanical process (e.g., drilling, cutting, carving, etc.), adhesives, or otherwise. In some examples, the opening 114 can be threaded. For example, the opening 114 in the second component 106 can be threaded and configured to engage the double-ended stud 110.

While FIG. 1a illustrates the fastener system 100 as being coupled to the first component 104 via the nut 108, other fastening techniques and arrangements are contemplated. For example, rather than a threaded nut 108, a friction-based fastener can be used (e.g., a clip, sleeve, etc.). In another example, an opening 114 formed in the first component 104 can be threaded and configured to engage the second shank 110b of the double-ended stud 110, thus obviating the need for additional fasteners (e.g., nut 108).

After the first component 104 and the second component 106 are assembled, as best illustrated in FIG. 1b, the second component 106 can be covered at least partially by the first component 104. In some examples, one or both of the first component 104 and the second component 106 can include additional attachment features.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, spoilers, door trim panels, moldings, trim pieces, and other substrates (whether used as interior or exterior surfaces). The second component 106 may be, for example, a frame, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

The illustrated double-ended stud 110 comprises a first shank 110a and a second shank 110b. While the first shank 110a of the double-ended stud 110 is illustrated as shorter in length than the second shank 110b, in other examples the first shank 110a can be the same length or longer than the second shank 110b. The first shank 110a and the second shank 110b can each define one or more threads, which are configured to engage one of the nut 108 (or other type of female fastener) and/or the base assembly 112 (e.g., via a passageway 118 formed therein).

The base assembly 112 is illustrated as a multi-component having a base component 120 and a seal 122. The seal 122 may be embodied as a ring (e.g., an annulus). In one example, the base component 120 can be a rigid plastic structure and the seal 122 is a softer material that is over-molded onto the base component 120 to form the base assembly 112.

The base component 120 generally comprises a pair of platforms 120a, 120b (i.e., a first platform 120a and a second platform 120b) spaced apart via a stem 120c. The base component 120 defines the passageway 118 along the central axis 124 that is configured receive and/or engage an end of the first shank 110a. While the passageway 118 is illustrated as passing through the base component 120 entirely (e.g., forming an opening on each side of the base component 120), the passageway 118 need not pass through the base component 120 entirely and may stop short such that one side (e.g., at the first platform 120a) does not define an opening. The passageway 118 can be threaded or unthreaded. For example, the passageway 118 can be unthreaded (e.g., having a smooth interior surface) and configured for use with a double-ended stud 110 having self-threading threads.

During assembly, the first shank 110a of the double-ended stud 110 can be inserted into the passageway 118 and rotated relative to the base assembly 112 about the central axis 124 of rotation to join the double-ended stud 110 to the base assembly 112 and thereby form the fastener assembly 102. Once assembled, the first platform 120a can be slid into the slot 126 of the doghouse structure 116, thus securing the fastener assembly 102 relative to the second component 106. The second shank 110b of the double-ended stud 110 can then be inserted into the opening 114 formed in the first component 104. The nut 108 can be installed on and rotated relative to the second shank 110b of the double-ended stud 110 about the central axis 124 to join and compress the first component 104 and the seal 122 against the second platform 120b. The seal 122 abuts a surface of the first component 104 at or adjacent the opening 114 of the first component 104.

It is contemplated that certain components of the stud fastener assembly 102 may be fabricated from metal, while others can be fabricated from a plastic or a flexible material.

The double-ended stud 110 and nut 108, for example, can be fabricated from metal using, for example, a metal-drawing or other metal-forming technique. By way of example, the body of the double-ended stud 110 and/or nut 108 can be fabricated using a cold metal forming technique, where threading is added via a thread rolling or tapping technique. The double-ended stud 110 and/or nut 108 can be heat treated to enhance strength and hardness.

The base assembly 112 can be fabricated from a plastic material using a plastic injection technique, additive manufacturing, or otherwise. It is contemplated, however, that the double-ended stud 110 and/or the base assembly 112 could also be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In one example, the base component 120 is formed of a plastic (e.g., a 3D-printed or injection-molded part) or other such material and configured to interact with a drawn metal compression-limiting seal 122.

The seal 122 may be fabricated from a foam material, thermoplastic, rubber, etc. For example, the seal 122 can be configured to surround a portion of the double-ended stud 110 (e.g., the second platform 120b) and positioned to form a seal between the second platform 120b and the first component 104.

The stud fastener assembly 102 may be sized as desired to accommodate first and second components 104, 106 of various sizes. In one example, with reference to FIG. 1f, the width (W1) of the first platform 120a can be between 15 mm and 25 mm (or about 20 mm), while the width (W2) (or outer diameter) of the seal 122 can be between 20 mm and 30 mm (or about 25 mm). The height (H1) of the stud fastener assembly 102 (i.e., the distance between the exterior surfaces of the first platform 120a and distal end of the second shank 110b) can be between 20 mm and 30 mm (or about 25 mm). Turning to FIG. 1g, the width (W3) (or outer diameter) of the first shank 110a can be between 2 mm and 8 mm (or about 5 mm), while the width (W4) (or inner diameter) of the second platform 120b can be between 20 mm and 30 mm (or about 24 mm) and the thickness (T1) of the second platform 120b can be between 1 mm and 3 mm (or about 2 mm). The height (H2) of the seal 122 (e.g., at the perimeter) can be between 2 mm and 8 mm (or about 5 mm). The height (H3) of the base component 120 can be between 5 mm and 15 mm (or about 7.5 mm), while the height (H4) of the base component 120 with the seal 122 can be between 5 mm and 15 mm (or about 10 mm).

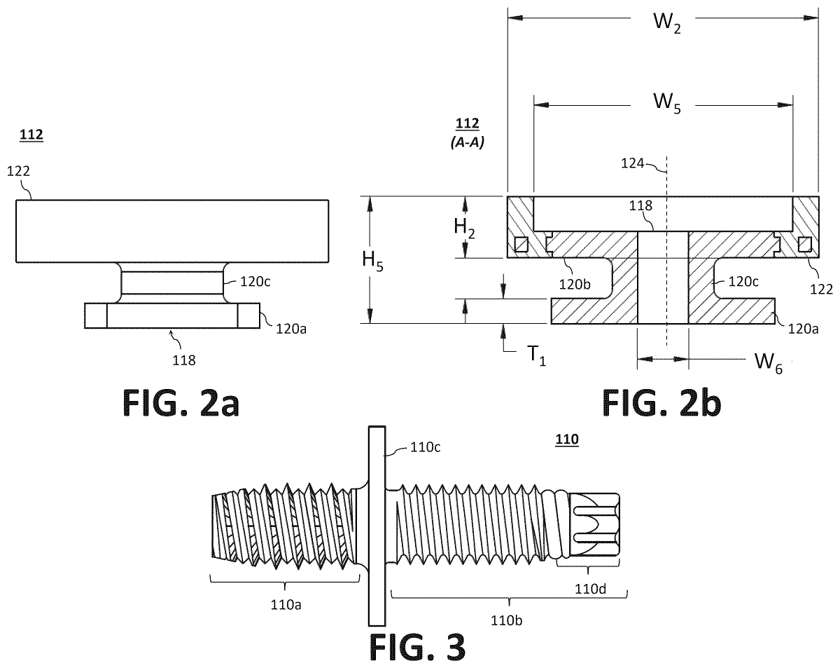

FIG. 2a illustrates a side elevation view of a base assembly 112 of the stud fastener assembly 102 of FIGS. 1a through 1g in accordance with an aspect of this disclosure, while FIG. 2b illustrates a side elevation view of the base assembly 112 taken along cutline A-A (FIG. 1e).

Each of the first platform 120a and the second platform 120b is illustrated as generally planar, but other shapes (e.g., concave, convex, etc.) can be used to complement a shape of its respective first component 104 or second component 106. Similarly, while each of the first platform 120a and the second platform 120b is illustrated as generally quadrilateral (e.g., square) with rounded or chamfered corners, other shapes are contemplated, including, for example, circular, oval, triangular, and non-quadrilateral polygons.

The base assembly 112 may be sized as desired to accommodate first and second components 104, 106 of various sizes. In one example, with reference to FIG. 2b, the width (W5) (or inner diameter) of a cavity defined by the seal 122 can be between 15 mm and 25 mm (or about 21 mm) and the width (W6) (or inner diameter) of the passageway 118 can be between 2 mm and 8 mm (or about 4 mm). As can be appreciated, the diameter of the passageway 118 may be smaller than the diameter of the first shank 110a to enable the threading of the first shank 110a to dig into the material (e.g., inner sidewall) of the passageway 118.

FIG. 3 illustrates a side elevation view of a double-ended stud 110 of the stud fastener assembly 102 of FIGS. 1a through 1g in accordance with an aspect of this disclosure. The diameter, thread pitch, type of threads, etc. can be adjusted or selected to meet a particular need based on, for example, the size and material type of the nut 108 and/or the base assembly 112.

In one example, and with reference to FIG. 3, the first shank 110a may be formed with a Boscrew™ and/or the second shank 110b could be M6.0×1.0 Class and with a self-correcting thread design to mitigate thread damage or seizing (e.g., a MATpoint® thread). The Boscrew™, for example, is engineered with a thread form that works directly with the creeping aspect of plastic to interlock with a boss and to not loosen in plastic applications. Additional details of the threading of the Boscrew™ are described in connection with commonly-owned U.S. Pat. No. 7,677,851 to Desai et al.

In the illustrated example, a collar 110c (e.g., platform or plate) is positioned between the first shank 110a and the second shank 110b. The second shank 110b can further define a head 110d configured to engage a tool to facilitate rotation of the double-ended stud 110 about the central axis 124 during installation. The head 110d can be shaped to define one or more driver shapes such as, for example, one or more slotted, Phillips, pozidriv, torx (star), hex (Allen), square (Robertson), tri-wing, torq-set, spanner (snake eyes), clutch type, hexalobular, bristol, spline drive, etc.

The above-cited patents and patent publications are hereby incorporated by reference in their entirety. While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastener assembly to couple a first component to a second component via an opening associated with the first component and a doghouse structure associated with the second component, the fastener assembly comprising:
a double-sided stud having a first shank and a second shank, wherein the second shank is configured to pass through the opening to secure with a nut; and
a base component having a first platform spaced apart from a second platform via a stem,
wherein the base component defines a passageway configured to receive at least a portion of the first shank, and
wherein the first platform is configured to secure with the doghouse structure.

2. The fastener assembly of claim 1, further comprising a seal.

3. The fastener assembly of claim 2, wherein the seal is coupled to the second platform.

4. The fastener assembly of claim 1, wherein the second shank comprises as its distal end a head.

5. The fastener assembly of claim 4, wherein the head is configured to define one or more driver shapes.

6. The fastener assembly of claim 1, wherein the base component is plastic.

7. The fastener assembly of claim 1, wherein the double-sided stud is metal.

8. The fastener assembly of claim 1, wherein the seal is a foam material, thermoplastic, or a rubber.

9. The fastener assembly of claim 1, wherein the double-sided stud comprises a collar positioned between the first shank and the second shank.

10. The fastener assembly of claim 9, wherein the collar is configured to abut the second platform when assembled.

11. A base component to couple a first component to a second component via a double-sided stud having a first shank and a second shank, the base component comprising:
a first platform; and
a second platform spaced apart from the first platform via a stem,
wherein the base component defines a passageway configured to receive at least a portion of the first shank, and
wherein the first platform is configured to secure with a doghouse structure formed on the second component.

12. The base component of claim 11, further comprising a seal.

13. The base component of claim 12, wherein the seal is coupled to the second platform.

14. The base component of claim 11, wherein the base component is plastic.

15. The base component of claim 11, wherein the seal is a foam material, thermoplastic, or a rubber.

16. A fastener assembly to couple a first component to a second component via an opening associated with the first component and a doghouse structure associated with the second component, the fastener assembly comprising:
a double-sided stud having a first shank and a second shank, wherein the second shank is configured to pass through the opening to secure with a nut;
a plastic base component having a first platform spaced apart from a second platform via a stem,
wherein the plastic base component defines a passageway configured to receive at least a portion of the first shank, and
wherein the first platform is configured to secure with the doghouse structure; and
a seal coupled to the second platform.

17. The fastener assembly of claim 16, wherein the second shank comprises as its distal end a head configured to define one or more driver shapes.

18. The fastener assembly of claim 16, wherein the double-sided stud is metal and comprises a collar positioned between the first shank and the second shank.

19. The fastener assembly of claim 18, wherein the collar is configured to abut the second platform when assembled.
